(19) United States
(12) Patent Application Publication
(10) Pub. No.: US 2019/0058293 A1
(43) Pub. Date: Feb. 21, 2019

(54) ELECTRICAL CONNECTOR WITH STACKED SHIELDING PLATES SANDWICHED BETWEEN TWO OPPOSITE CONTACT MODULES

(71) Applicant: FOXCONN INTERCONNECT TECHNOLOGY LIMITED, Grand Cayman (KY)

(72) Inventors: JIAN-KUANG ZHU, Kunshan (CN); WEI ZHONG, Kunshan (CN)

(21) Appl. No.: 16/105,954

(22) Filed: Aug. 20, 2018

(30) Foreign Application Priority Data
Aug. 18, 2017 (CN) 201710712338.3

(51) Int. Cl. H01R 13/6597; H01R 13/6585; H01R 13/405; H01R 13/504

(52) U.S. Cl. CPC H01R 13/6597; H01R 13/6585; H01R 24/60; H01R 13/504; H01R 13/405

(57) ABSTRACT

A high frequency electrical connector includes a housing with first and second rows of contacts therein. The housing includes a base and a mating tongue extending forwardly from the base. Each contacts has a contacting section exposed upon the mating surface of the mating tongue, a connection section exposed out of the base, and a middle section therebetween. The first row of contacts as well as the second row of contacts includes a plurality of grounding contacts. First and second shielding plates stacked with each other and commonly between the first row of contacts and the second row of contacts. The first shielding plate and the second shielding plate form corresponding spring tangs offset from each other in the front-to-back direction to respectively contact the first grounding contacts and second grounding contacts at different positions in the front-to-back direction.

### BACKGROUND OF THE INVENTION

### 1. Field of the Invention

The present invention relates to a high frequency electrical connector, and particularly to the electrical connector with stacked shielding plates sandwiched between a pair of contact modules wherein each shielding plate includes at least one spring tang mechanically and electrically connecting to one grounding contact. This instant application relates to a copending application with the same applicant, the same filing date and the same title thereof.

### 2. Description of Related Art

Using a spring tang punched out of a metallic plate to contact a grounding contact for enhancing grounding effect, is essentially a popular method. Anyhow, when such a metallic plate is shared by multiple items thereabouts, it is relatively difficult to provide sufficient grounding structures in the limited space thereabouts.

It is desired to have an electrical connector with sufficient metallic structures to provide sufficient shielding and/or grounding effect thereabouts.

### SUMMARY OF THE INVENTION

An object of the invention is to provide a high frequency electrical connector with a housing with first and second rows of contacts therein. The housing includes a base and a mating tongue extending forwardly from the base. Each contacts has a contacting section exposed upon the mating surface of the mating tongue, a connection section exposed out of the base, and a middle section therebetween. The first row of contacts as well as the second row of contacts includes a plurality of grounding contacts. First and second shielding plates stacked with each other and commonly between the first row of contacts and the second row of contacts. Each shielding plate has at least one row of spring tangs wherein the spring tangs of the first shielding plate with regard to the corresponding grounding contacts of the first row of contacts are essentially offset from the spring tangs of the second shielding plate with regard to the corresponding grounding contacts of the second row of contacts in a top view so as to assure the superior shielding effect in the vertical direction, compared with the single layer shielding plate arrangement.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector according to the invention;

FIG. 2 is an exploded perspective view of and the corresponding contacts of the electrical connector of FIG. 1;

FIG. 3 is an exploded perspective view of the shielding plates of the electrical connector of FIG. 1;

FIG. 4 is a side view of the stacked shielding plates with the associated contacts of the electrical connector of FIG. 1;

FIG. 5 is a perspective view of another embodiment of the electrical connector;

FIG. 6 is an exploded perspective view of the electrical connector of FIG. 5;

FIG. 7 is a perspective view of the shielding plates of the electrical connector of FIG. ;

FIG. 8 is an exploded perspective view of the shielding plates of the electrical connector of FIG. 7;

FIG. 9 is a side view of the shielding plates with the corresponding grounding contacts of the electrical connector of FIG. 6;

FIG. 10 is a perspective view of a third embodiment of the shielding plates of the invention; and

FIG. 11 is a perspective view of the preformed shielding plates of the electrical connector of FIG. 10.

### DETAILED DESCRIPTION OF THE PREFERRED EMBODIMENT

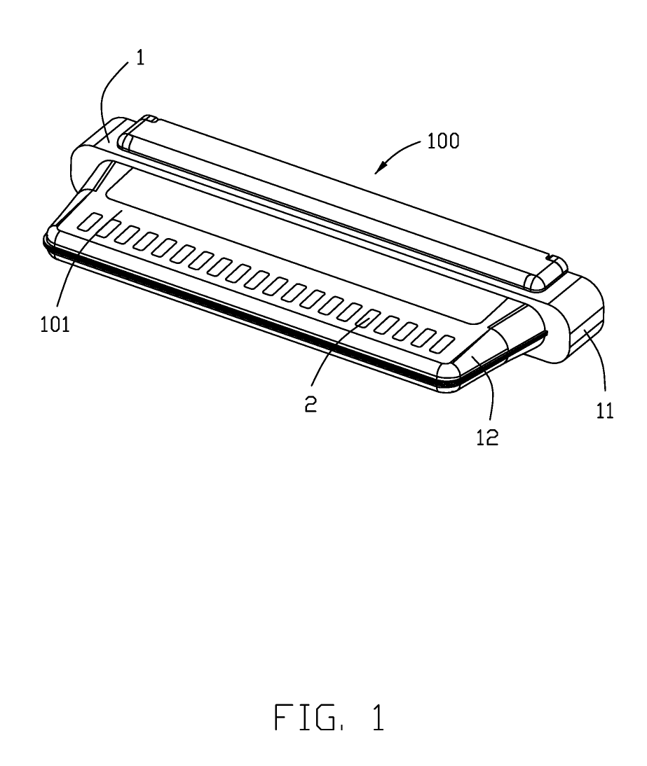

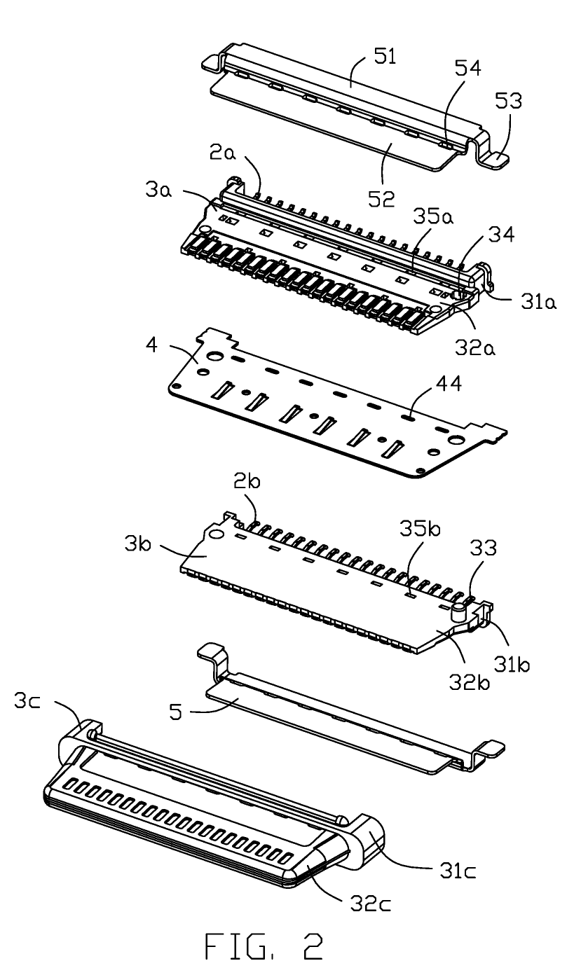

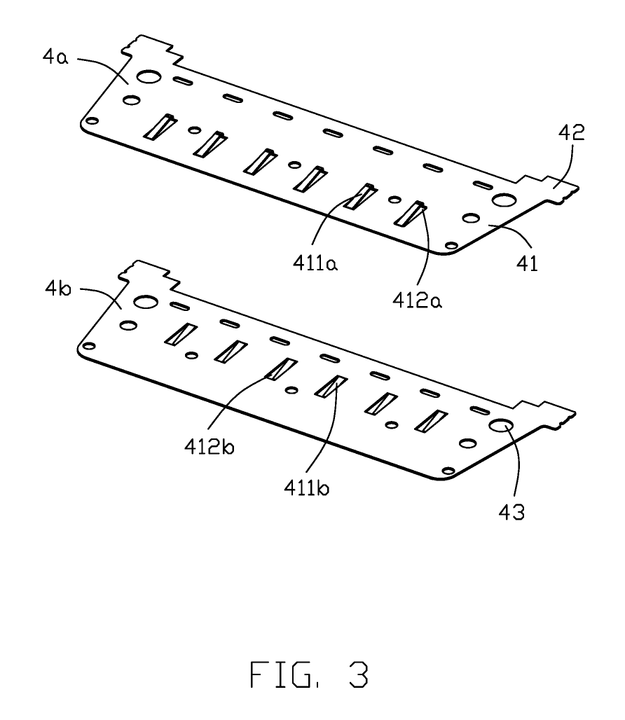

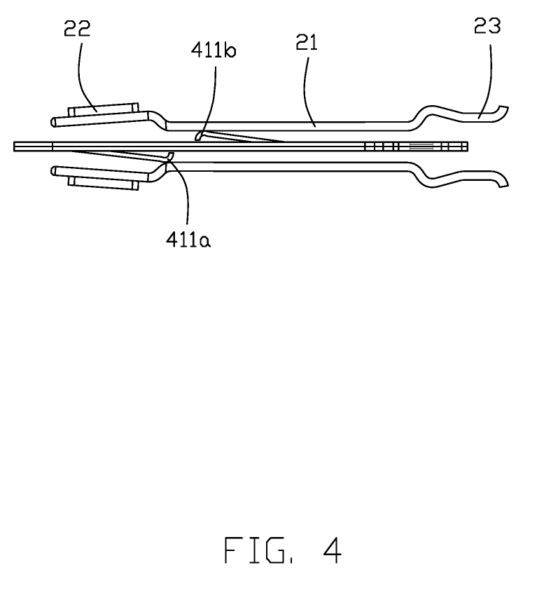

Referring to FIGS. 1-4, the electrical connector 100 includes an insulative housing 1 and a plurality of contacts 2 retained therein. The housing 1 includes a base 11 and a mating tongue 12 extending forwardly from the base 11 and having opposite mating surfaces 101. Each contact 2 has a contacting section 22 exposed upon the mating surface 101, a tail section 23 and a connecting section 21 therebetween.

The contacts 2 are arranged with first contacts 2a and second contacts 2b. The first contacts 2a are integrally formed within the first insulative block 3a via an insert-molding process, and the second contacts 2b are integrally formed within the second insulative block 3b via another insert-molding process. The first contacts have a plurality of first grounding contacts, and the second contacts are as well. The first insulative block 3a includes a first base 31a and a first mating tongue 32a extending from the first base 31a. The second insulative block 3b includes a second base 31b and a second mating tongue 32b extending from the second base 31b. Each mating tongue 32a, 32b has a positioning post 33 and a positioning hole 34 wherein the positioning post 33 of the first insulative block 3a is inserted into the positioning hole 34 of the second insulative block 3b, and the positioning post 33 of the second insulative block 3b is inserted into the positioning hole 34 of the first insulative block 3a so as to assemble the first insulative block 3a and the second insulative block 3b together.

The electrical connector 100 further includes a metallic shielding plate composed of a first shielding plate 4a and a metallic second shielding plate 4b stacked with each other in the vertical direction and commonly sandwiched between the first insulative block 3a and the second insulative block 3b. Each of the first shielding plate 4a and the second shielding plate 4b include a main body 41 and a pair of fixing legs 42 on two lateral sides. The main body 41 of the first shielding plate 4a forms around a front portion thereof a plurality of first spring tangs 411a in one row and the corresponding first openings 412a derived from forming the first spring tangs 411a. The main body 41 of the second shielding plate 4b forms around the middle portion a plurality of second spring tangs 411b and the corresponding second openings 412b. The first/second spring tang 411a, 411b respectively extend from corresponding inner edges of the corresponding first/second opening 412a, 412b away from the shielding plate 4 either toward or away from each other. Each first/second shielding plate 4a, 4b has the hole 43 for extension of the positioning post 33. The first shielding plate 4a and the second shielding plate 4b are fixed together via either soldering or welding. Because the first spring tangs 411a and the second spring tangs 411b are offset from each other in the front-to-back direction, the first openings 412a will be covered by the second shielding plate 4b, and the second openings 412b will be covered by the first shielding plate 4a. Therefore, there is no EMI leak between the first contacts 2a and the second contacts 2b. During assembling, the positioning post 33 of the first insulative block 3a and that of the second insulative block 3b extend through the holes 43 of the shielding plate 4 into the positioning holes 34, respectively, so as to fix the first insulative block 3a, the shielding plate 4 and the second insulative block 3b together. The first spring tang 411a contacts the connecting section 21 of the first grounding contact of the first contacts 2a, and the second spring tang 411b contacts the connecting section 21 of the second grounding contact of the second contacts 2b.

A pair of metallic shells 5 are attached upon the housing 1. Each shell 5 includes a blade 51 and an extension 52 extending from the blade 51 to the shielding plate 4, and a pair of legs 53 extending from the blade in an offset manner. The pair of shells 5 are respectively attached upon the exterior of the first insulative block 3 and second insulative block 4, respectively. The legs 53 abut against the corresponding legs 42, respectively. The first insulative block 3a, the second insulative block 3b and the shielding plate 4 are commonly loaded into the mold for an overmolding process wherein the metal shell 5, the first insulative block 3a, the shielding plate 4 and the second insulative block 3b have the positioning hole 554, 35a, 44 and 35b so as to allow the corresponding core pins to extend therethrough during the overmolding process. A third insulative block 3c is applied upon the first insulative block 3a, the shells 5 and the second insulative block 3b, and includes a third base 31c, and a third mating tongue 32c extending forwardly from the third base 31c. The first base 31a, the second base 31b and the third base 31c commonly form the base 11. The first mating tongue 32a, the second mating tongue 32b and the third mating tongue 32c commonly form the mating tongue 12. A portion commonly related to the blade 51 and the extension 52 and the mounting legs 53 is exposed outside of the base 11. The extension 52 is exposed upon the mating surface 121.

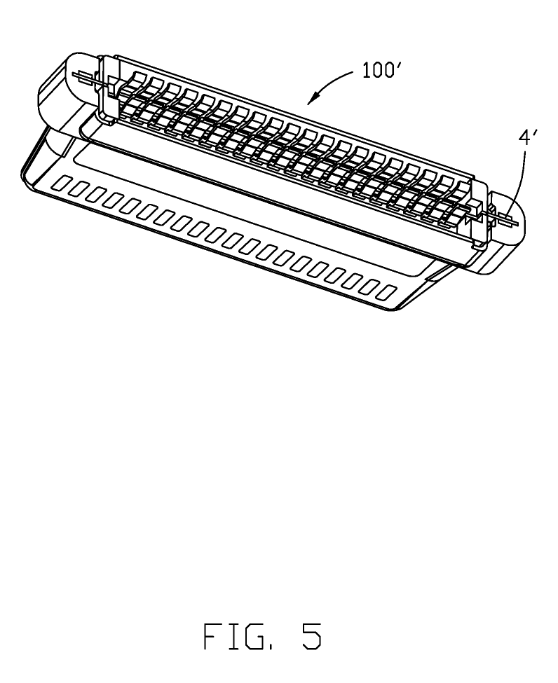

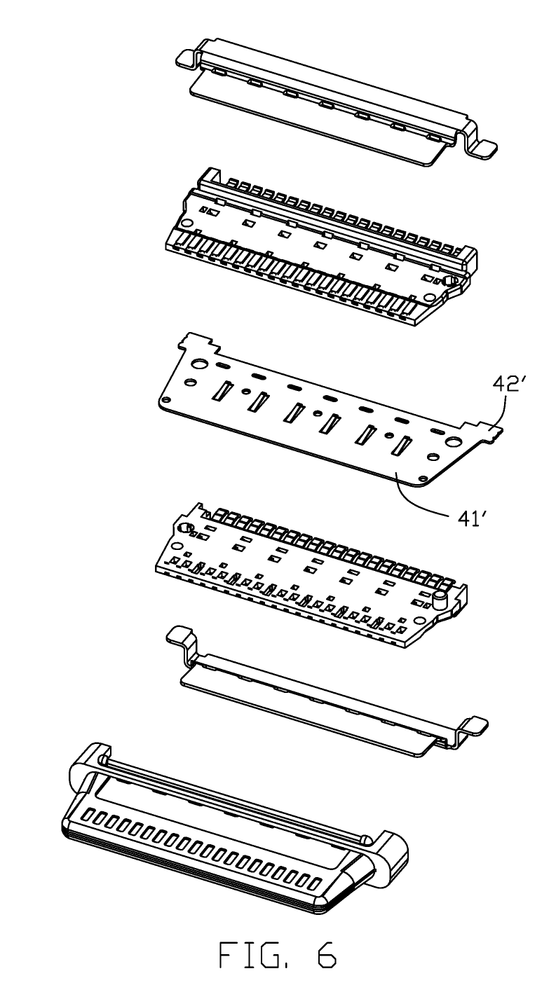

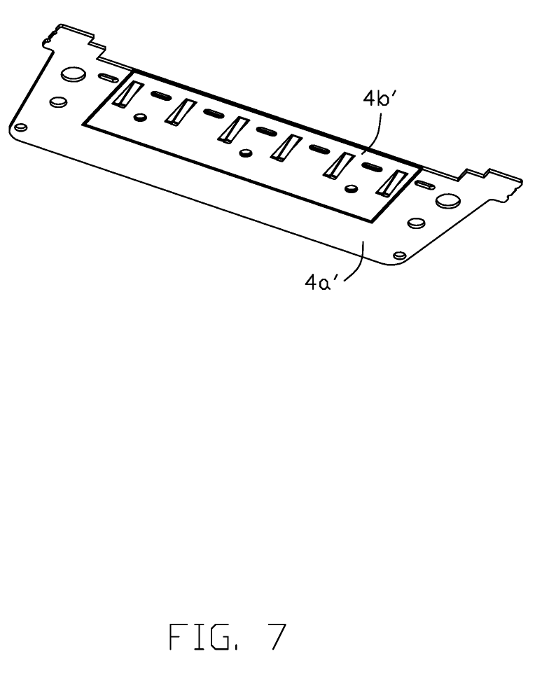

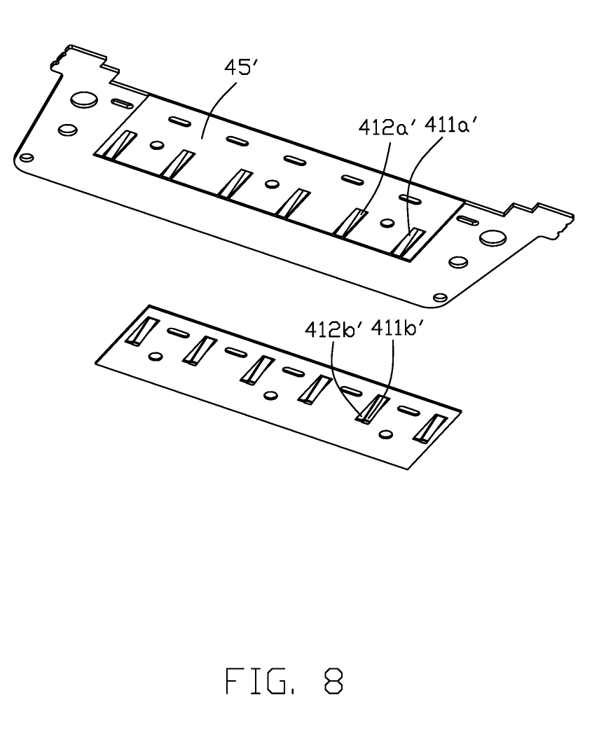

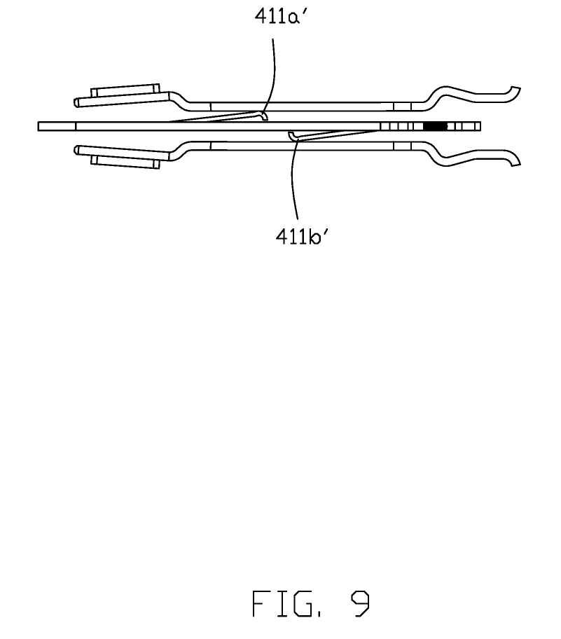

Referring to FIGS. 5-9, the electrical connector 100′ has the similar structure with the electrical connector 100 except the shielding plate 4. The shielding plate 4′ includes a first shielding plate 4a′ and a second shielding plate 4b′. The first shielding plate 4a includes the main body 41′, a pair of fixing legs 42′ , and a thinned area 45′ which is recessed. The first spring tangs 411a′ are formed in the thinned area 45′. The second shielding plate 4b′ is dimensioned similar to the thinned area 45′, and soldered to the thinned area 45′. The first spring tangs 411a′ is located on a front portion of thinned area while the second spring tangs 411b are located on a rear portion of the second shielding plate 4b so as to have the first spring tangs offset from the second sprint tangs in the front-to-back direction. Therefore, the opening 412a′ is covered by the second shielding plate 4b′, and the opening 412b′ is covered by the first shielding plate 4a′. The second shielding plate 4b′ is also thinned so as to cooperate with the thinned area 45′ to be equal to the thickness of the first shielding plate 4a′. In this embodiment, each of the thinned area 45′ and the second shielding plate 4b′ is one half of that of the first shielding plate 4a′.

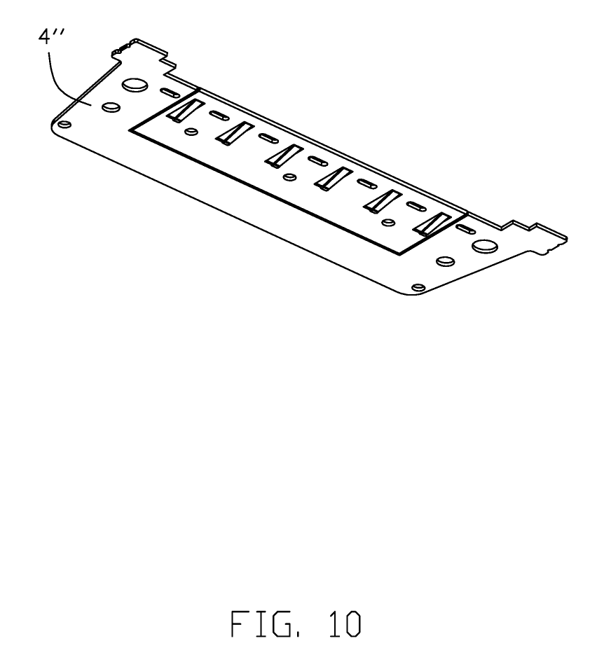

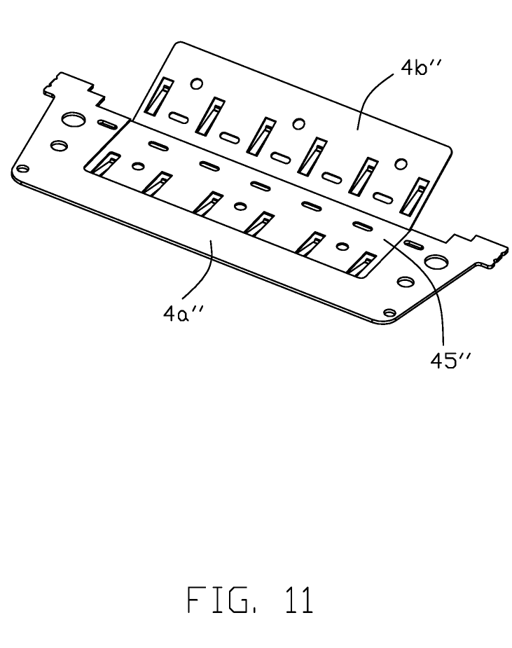

FIGS. 10-11 show the third embodiment wherein the electrical connector 100″ is similar to the electrical connector 100′ of the second embodiment except the second shielding plate 4b″ unitarily extends from the thinned area 45″ with the same thickness which is essentially one half of that of the first shielding plate 4a″. The second shielding plate 4b″ is folded into the recess in the thinned area 45″ and soldered thereto.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. An electrical connector comprising:
a first contact module with a plurality of first contact retained therein in a transverse direction via an insert-molding process and including a plurality of first grounding contacts thereof;
a second contact module with a plurality of second contacts retained therein in the transverse direction via another insert-molding process and having a plurality of second grounding contacts thereof; and
opposite metallic first and second shielding plates stacked with each other and commonly sandwiched between the first contact module and the second contact module in a vertical direction perpendicular to the transverse direction; wherein
the first shielding plate forms a plurality of first spring tangs in one row and extending toward and contacting the corresponding first grounding contact, and the second shielding plate forms a plurality of first spring tangs in another row and extending toward and contacting the corresponding second grounding contact; wherein
the first spring tangs are offset from the second sprint tangs in a front-to-back direction perpendicular to both the vertical direction and the transverse direction

2. The electrical connector as claimed in claim 1, wherein the first shielding plate forms a plurality of openings derived from the first spring tangs and covered by the second shielding plate in the vertical direction, and the second shielding plate forms a plurality of opening derived from the second spring tangs and covered by the first shielding plate in the vertical direction.

3. The electrical connector as claimed in claim 1, wherein the first spring tangs and the second spring tangs extend in opposite directions along the front-to-back direction.

4. The electrical connector as claimed in claim 3, wherein the first spring tangs and the second spring tangs extend toward each other in the front-to-back direction.

5. The electrical connector as claimed in claim 4, wherein each of said first contacts and said second contacts includes a front contacting section, a rear tail section and a connecting section therebetween, and both the first sprint tang and said second spring tang contact the connecting section of the corresponding first contact and second contact, respectively.

6. The electrical connector as claimed in claim 1, wherein the first shielding plate forms a plurality of holes aligned with those formed in the first contact module in the vertical direction.

7. The electrical connector as claimed in claim 1, wherein the first shielding plate forms a plurality of holes aligned with those formed in the second shielding plate in the vertical direction.

8. The electrical connector as claimed in claim 1, wherein the first shielding plate forms a thinned area to receive the thinned second shielding plate therein.

9. The electrical connector as claimed in claim 8, wherein said second shielding plate unitarily extends from an edge of the thinned area.

10. The electrical connector as claimed in claim 9, wherein both the thinned area and the second shielding plate defines a thickness being one half of that of the first shielding plate.

11. The electrical connector as claimed in claim 8, wherein the first spring tangs are formed in the thinned area.

12. An electrical connector comprising:
an insulative housing having a base and a mating tongue forwardly extending from the base;
a plurality of first contacts arranged in a first row along a transverse direction and commonly retained in the housing;
a plurality of second contacts arranged in a second row along said transverse direction and commonly retaining in the housing;
opposite metallic first and second shielding plates stacked with each other and commonly sandwiched between the first contact module and the second contact module in a vertical direction perpendicular to the transverse direction; wherein
the first shielding plate forms a plurality of first spring tangs in one row and extending toward and contacting the corresponding first grounding contact, and the second shielding plate forms a plurality of first spring tangs in another row and extending toward and contacting the corresponding second grounding contact; wherein
the first spring tangs are offset from the second sprint tangs in a front-to-back direction perpendicular to both the vertical direction and the transverse direction.

13. The electrical connector as claimed in claim 12, wherein the first shielding plate forms a plurality of openings derived from the first spring tangs and covered by the second shielding plate in the vertical direction, and the second shielding plate forms a plurality of opening derived from the second spring tangs and covered by the first shielding plate in the vertical direction.

14. The electrical connector as claimed in claim 12, wherein the first spring tangs and the second spring tangs extend in opposite directions along the front-to-back direction.

15. The electrical connector as claimed in claim 14, wherein the first spring tangs and the second spring tangs extend toward each other in the front-to-back direction.

16. The electrical connector as claimed in claim 15, wherein each of said first contacts and said second contacts includes a front contacting section, a rear tail section and a connecting section therebetween, and both the first sprint tang and said second spring tang contact the connecting section of the corresponding first contact and second contact, respectively.

17. An electrical connector comprising:
a first contact module with a plurality of first contact retained therein in a transverse direction via an insert-molding process and including a plurality of first grounding contacts thereof;
a second contact module with a plurality of second contacts retained therein in the transverse direction via another insert-molding process and having a plurality of second grounding contacts thereof; and
opposite metallic first and second shielding plates stacked with each other and commonly sandwiched between the first contact module and the second contact module in a vertical direction perpendicular to the transverse direction; wherein
the first shielding plate forms a plurality of first spring tangs in one row and extending toward and contacting the corresponding first grounding contact, and the second shielding plate forms a plurality of first spring tangs in another row and extending toward and contacting the corresponding second grounding contact; wherein
the first shielding plate forms a thinned area to receive the thinned second shielding plate therein.

18. The electrical connector as claimed in claim 17, wherein said second shielding plate unitarily extends from an edge of the thinned area.

19. The electrical connector as claimed in claim 18, wherein both the thinned area and the second shielding plate defines a thickness being one half of that of the first shielding plate.

20. The electrical connector as claimed in claim 17, wherein the first shielding plate forms a plurality of holes aligned with those formed in the second shielding plate in the vertical direction.
